(19) United States
(12) Patent Application Publication
(10) Pub. No.: US 2025/0388497 A1
(43) Pub. Date: Dec. 25, 2025

(54) Processing Of Phosphate Compounds

(71) Applicant: EasyMining Sweden AB, Sollentuna (SE)

(72) Inventors: Yariv COHEN, Uppsala (SE); Michael NORDSTRÖM, Uppsala (SE)

(21) Appl. No.: 19/107,723

(22) PCT Filed: Sep. 12, 2023
(86) PCT No.: PCT/SE2023/050892

§ 371 Date: Feb. 28, 2025

(30) Foreign Application Priority Data
Sep. 14, 2022 (SE) 2251063-0

(51) Int. Cl. C02F 1/52; C02F 1/00; C02F 11/148; C02F 101/10

(52) U.S. Cl. CPC C02F 1/5245; C02F 1/004; C02F 11/148; C02F 2101/105; C02F 2209/06

(57) ABSTRACT

A method for processing of phosphate compounds comprises providing (S10) of a primary liquid being an acid solution comprising at least phosphorous. Phosphate compounds comprising iron are precipitated (S20) from the primary liquid by adding (S22) a first additive material to the primary liquid. The first additive material comprises iron hydroxide and a solid filter-aid material. First solid matter, comprising the precipitated phosphate compounds and the solid filter-aid material is separated (S28) by a first filtering. The separated first solid matter is exposed (S30) for an alkaline solution, causing a dissolution (S32) of phosphate compounds and precipitation (S32) of iron hydroxide, which gives a secondary liquid. Second solid matter comprising the precipitated iron hydroxide and the solid filter-aid material is removed (S38) by a second filtering. Part of the second solid matter is recycled (S40) as the first additive material. A system for processing of phosphate compounds is also disclosed.

### TECHNICAL FIELD

The present technology refers in general to processing of phosphate compounds, and in particular to methods and systems for separating iron and phosphorus.

### BACKGROUND

Phosphorus is an important element, and indeed essential to life. However, the release of phosphorous to surface waters, and its consequent contribution to eutrophication, has also led to increasing concerns about water quality. Policies were therefore implemented throughout the world, to reduce the levels of phosphorus entering surface waters, by the implementation of technologies to remove phosphorus from domestic and industrial wastewater. As a consequence, phosphorus accumulates in sewage sludge which is a major byproduct of wastewater treatment plants.

Mineral phosphorus resources are considered limited and finite. Therefore, there is an increasing interest for technologies that can facilitate the recycling and beneficial re-use of the phosphorus present in wastes such as sewage sludge.

Many techniques for recovering of phosphorus have been presented. A few examples of related patent publications are the Japanese patent 9145038, the published European patent application EP2016203 A1, the published international patent application WO 00/50343 A1, the published international patent application WO 2008/115121 A1, and the published international patent application WO 03/000620 A1. Also in the scientific literature, different approaches are described, e.g. by Schaum et al. described in a conference (Conference on the Management of Residues Emanating from Water and Wastewater Treatment, 12 Aug. 2005, Johannesburg, South-Africa), by Franz, in Waste Manag. 2008; 28(10):1809-18), or by Dittrich et al. in a conference (International Conference on Nutrient Recovery from Wastewater Streams, Vancouver, 2009).

All these approaches are also discussed in the background section of the European Patent EP 3623348 B. In this patent, a method for processing materials containing phosphorous and at least one of iron and aluminium was disclosed. The presented process has been demonstrated to operate very well in general. However, minor problems have been encountered, which mainly may influence the economic aspects of the industrial implementation. One part process that was not completely free from additional consideration was the adding of a base comprising iron hydroxide and the following removal of precipitated phosphate compounds. It was for instance found that using filtering as a separation technique required frequent processing of the filtered solid substance for ensuring a satisfactory flow through the filter. Furthermore, depending on the process parameters, the efficiency in precipitating phosphate compounds could vary.

### SUMMARY

A general object of the present technology is thus to provide methods and systems for processing of phosphate compounds which are more efficient in phosphate compound precipitation and separation.

The above object is achieved by methods and devices according to the independent claims. Preferred embodiments are defined in dependent claims.

In general words, in a first aspect, a method for processing of phosphate compounds comprises providing of a primary liquid. The primary liquid is an acid solution comprising at least phosphorous. Phosphate compounds comprising iron are precipitated from the primary liquid. The precipitating of phosphate compounds comprising iron comprises adding of a first additive material to the primary liquid. The first additive material comprises iron hydroxide and a solid filter-aid material. First solid matter, comprising the precipitated phosphate compounds comprising iron and the solid filter-aid material is separated from the primary liquid by a first filtering. The separated first solid matter is exposed for an alkaline solution. The alkaline solution thereby causes a dissolution of phosphate compounds and precipitation of iron hydroxide, which gives a secondary liquid. Second solid matter comprising the precipitated iron hydroxide and the solid filter-aid material is removed from the secondary liquid by a second filtering. The secondary liquid after the removing is an alkaline liquid solution comprising phosphorous. At least a first part of the second solid matter is recycled as at least a part of the first additive material.

In a second aspect, a system for processing of phosphate compounds comprises a phosphate compound precipitation section, an iron hydroxide precipitation section and a recycling arrangement. The phosphate compound precipitation section comprises a primary liquid inlet for a primary liquid. The primary liquid is an acid solution comprising at least phosphorous. The phosphate compound precipitation section comprises an additive material inlet for a first additive material. The first additive material comprises iron hydroxide and a solid filter-aid material. The phosphate compound precipitation section comprises a first arrangement for mixing the primary liquid and the first additive material, causing precipitation of phosphate compounds comprising iron. The phosphate compound precipitation section comprises a first filter configured for separating first solid matter of the precipitated phosphate compounds comprising iron and the solid filter-aid material from the primary liquid. The phosphate compound precipitation section comprises a first solid matter outlet for the first solid matter. The phosphate compound precipitation section comprises a filtered primary liquid outlet for filtered primary liquid. The iron hydroxide precipitation section comprises a solid matter inlet for the first solid matter, connected to the first solid matter outlet. The iron hydroxide precipitation section comprises an alkaline solution inlet for an alkaline solution. The iron hydroxide precipitation section comprises a second arrangement for mixing the first solid matter and the primary liquid and the alkaline solution, causing precipitation of iron hydroxide in a secondary liquid. The iron hydroxide precipitation section comprises a second filter for removing second solid matter of the precipitated iron hydroxide and the solid filter-aid material from the secondary liquid. The iron hydroxide precipitation section comprises a second solid matter outlet for the second solid matter. The iron hydroxide precipitation section comprises a filtered secondary liquid outlet for filtered secondary liquid. The secondary liquid is an alkaline liquid solution comprising phosphorous. The recycling arrangement has a first connection, connecting the second solid matter outlet to the additive material inlet. The first connection is configured for recycling at least a first part of the second solid matter as at least a part of the first additive material. The recycling arrangement further comprises a partitioning arrangement configured for partitioning a second part of the second solid matter, and an extractor configured for extracting iron compounds from the second part of the second solid matter. The extractor comprises a reactor in which the second part of the second solid matter is exposed for a hydrochloric acid solution, thereby dissolving iron, producing an iron chloride solution, and a recovering arrangement configured for recovering solid filter-aid material from the second part of the second solid matter.

One advantage with the proposed technology is that an improved filtering is achieved without extensive consumption of additives. Other advantages will be appreciated when reading the detailed description.

### BRIEF DESCRIPTION OF THE DRAWINGS

The invention, together with further objects and advantages thereof, may best be understood by making reference to the following description taken together with the accompanying drawings, in which:

FIG. 1 illustrates a known example of processing of phosphate compounds;

FIG. 2 is a flow diagram of steps of an embodiment of a method for processing of phosphate compounds;

FIG. 3 is a diagram illustrating filtration times for iron hydroxide using different filter aid materials;

FIG. 4 is a schematic drawing of parts of an embodiment of a system for processing of phosphate compounds;

FIG. 5 is a flow diagram of steps of another embodiment of a method for processing of phosphate compounds;

FIG. 6 is a schematic drawing of parts of another embodiment of a system for processing of phosphate compounds;

FIG. 7 is a flow diagram of steps of yet another embodiment of a method for processing of phosphate compounds;

FIG. 8 is a schematic drawing of parts of yet another embodiment of a system for processing of phosphate compounds;

FIG. 9 is a flow diagram of part steps of an embodiment of a step of providing a primary liquid;

FIG. 10 is a schematic drawing of parts of an embodiment of a leachate reactor;

FIG. 11 is a diagram of experiments of phosphorous extraction efficiency;

FIGS. 12A-B are diagrams illustrating time dependencies of reactions between a primary liquid and iron hydroxide;

FIG. 13 is a flow diagram of steps of yet another embodiment of a method for processing of phosphate compounds; and

FIG. 14 is a schematic drawing of parts of yet another embodiment of a system for processing of phosphate compounds.

### DETAILED DESCRIPTION

Throughout the drawings, the same reference numbers are used for similar or corresponding elements.

For a better understanding of the proposed technology, it may be useful to begin with a brief overview of some detailed problems with the implementation of systems according to the patent EP 3623348 B.

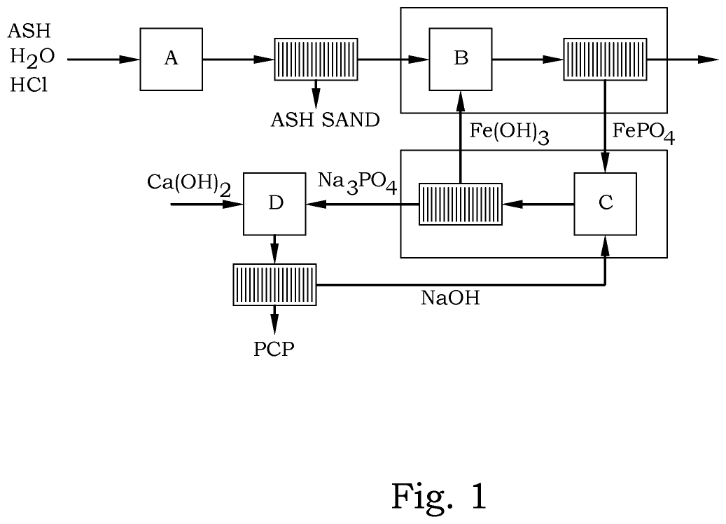

In one implementation, as schematically illustrated in FIG. 1, sewage sludge ash was dissolved in a water solution of hydrochloric acid. Remaining non-dissolved residues were separated as ash sand. The acid solution comprising at least phosphorous and iron was mixed with iron hydroxide, and iron phosphate compounds were precipitated. The precipitated iron phosphate compounds were separated and subsequently exposed for sodium hydroxide, which resulted in precipitated ferric hydroxide and sodium phosphate in solution. A part of the ferric hydroxide could be used in a subsequent batch of precipitating iron phosphate compounds. Calcium hydroxide was added to the separated sodium hydroxide solution, which resulted in precipitated calcium phosphate (PCP) in a solution of sodium hydroxide. Sodium hydroxide separated from this could be reused in a subsequent batch of exposing the precipitated iron phosphate for sodium hydroxide.

When the process was implemented with standard filtering techniques for removing precipitated ferric hydroxide, some disadvantages were found. Regardless of filters, the ferric hydroxide formed a relatively thin layer of filtered substances as a compressible filter cake. Upon application of pressure over the filter cake, to speed up the separation, the filter cake compressed and formed a compact layer that was relatively efficient in blocking further penetration of liquids through the filter. At the same time, this compressed filter cake was not mechanically stable enough by itself and mechanical removal was therefore difficult. Altogether, even if the process indeed was operable as such, the filtering times became too long for being attractive in efficient large scale industrial applications.

In filtering experiments, it was found that the filtering properties of iron hydroxide could be improved by adding an inert filter aid into the solution before filtering. One example of such an inert filter aid is perlite, which was proven to withstand the high pH of the solution to be filtered. A drawback was, however, that relatively high amounts of filter aid was required. At 10% by weight of the filter aid, compared to the iron hydroxide to be filtered, some improvements in filtering properties were found. In order to improve the filtering properties, even high contents of filter aid were required. Preferably above 30% by weight and more preferably about 50% by weight of filter aid is added to the solution prior to filtering.

The high content of filter aid needed for giving useful filtering conditions of course causes high additional costs. Consumption of large amounts of filter aid is economically non-viable in industrial applications. Furthermore, the filter cakes comprise the mix of filter aid and iron hydroxide and are as such not very attractive as commercial products. There is a possibility to postprocess the filter cakes for separating the filter aid, but this is relatively costly and removes the possibility to reuse the iron content in the form of iron hydroxide.

However, it was found that the filter aid also was inert for highly acid conditions and could withstand solutions of at least pH down to 0. Moreover, it was found that the filter aid did not influence the chemical reactions between iron hydroxide and phosphate ions. The filter aid also operated well for being filtered together with precipitated phosphorous compounds comprising iron. This surprisingly opened up for allowing the filter aid to be recirculated together with the iron hydroxide in the process.

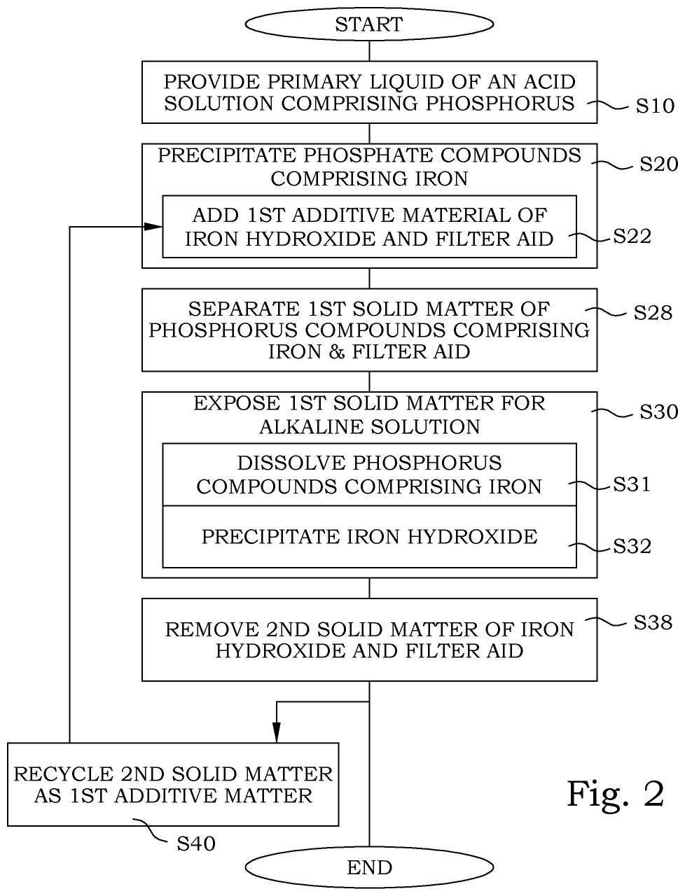

FIG. 2 is a flow diagram of steps of an embodiment of a method for processing of phosphate compounds. In step S10, a primary liquid is provided. This primary liquid is an acid solution comprising at least phosphorous. This primary liquid can be provided in different ways, but one option is to generate it by leaching of sewage sludge ash. This particular embodiment will be discussed further below. However, the present ideas are applicable to many types of highly acid liquids comprising phosphorus. In step S20, phosphate compounds comprising iron are precipitated from the primary liquid. This step S20 of precipitating phosphate compounds comprising iron in turn comprises step S22 of adding of a first additive material to the primary liquid. The first additive material comprises iron hydroxide and a solid filter-aid material. Preferably, the pH of the primary liquid is adjusted to be in the range of 2.5-3.5, and most preferably around 3, to decrease the solubility of phosphate compounds comprising iron and to minimize precipitation of impurities. In step S28, a first solid matter is separated from the primary liquid by a first filtering. The first solid matter comprises the precipitated phosphate compounds comprising iron and the solid filter-aid material.

In step S30, the separated first solid matter is exposed for an alkaline solution. The alkaline solution thereby causes, as illustrated by step S31, a dissolution of phosphate compounds and, as illustrated by step S32, precipitation of iron hydroxide. This dissolution and precipitation give a remaining secondary liquid. In step S38, second solid matter is removed from the secondary liquid by a second filtering. The second solid matter comprises the precipitated iron hydroxide and the solid filter-aid material. The secondary liquid after the step of removing, S38, is thus an alkaline liquid solution comprising phosphorous. This alkaline liquid solution comprising phosphorous may in particular embodiments be postprocessed as discussed further below. In step S40, at least a first part of the second solid matter is recycled as at least a part of the first additive material.

In tests it was found that perlite dissolves only to a very limited extent during the cycling in acid-alkaline conditions, i.e. from pH 0-1 up to pH 12-14. Long term testing with repeated cycling of the filter cakes with filter-aid showed a general improved filtration characteristics. No deterioration, due to e.g., degradation or fouling of the filter aid material, of the filtration capacity over time was observed.

This approach, allowing the filter aid to accompany the circulation of iron within the process significantly reduces the costs. The filter aid is filtered together with phosphate compounds comprising iron in the first filtering and is filtered together with iron hydroxide in the second filtering. Besides an initial provision of a large amount of filter aid, only replacement of minor losses during the handling has to be added at later stages.

As will be discussed further below, if the primary liquid comprises iron, there will be a build-up of iron content within the circulation process. In such cases, a bleed of iron substances has to be removed from the process. In the above presented approach, the iron compounds are always mixed with the filter aid, which means that any bleed will also comprise filter aid, which then has to be compensated for in the process. This will also be discussed more in detail further below.

As mentioned above, large amounts of filter aid are preferably added to produce easily handling of filter cakes. In one embodiment, the additive material comprises the solid filter-aid material in an amount giving at least 15% by weight of the solid filter-aid material in the second solid matter. In a preferred embodiment, the additive material comprises the solid filter-aid material in an amount giving at least 45% by weight of the solid filter-aid material in the second solid matter, and most preferably the additive material comprises the solid filter-aid material in an amount giving at least 70% by weight of the solid filter-aid material in the second solid matter.

The filter aid material will be exposed both for strong acids and strong bases and should at least to a dominating fraction be inert in all these situations. In typical applications, the primary solution may have as low pH as 0.8 and the dissolution in the alkaline solution may take place at as high pH as 12.2. Thus in a preferred embodiment, the solid filter-aid material is chemically inert in the pH range from 0.8 to 12.2.

Furthermore, a porous solid filter aid material is believed to be more efficient, since the cofiltered substances in the first and second matter may be contained within such porous structures without significantly reduce the penetration rate of liquids through the filter cake. Thus, in one embodiment, the solid filter-aid material has a porous structure.

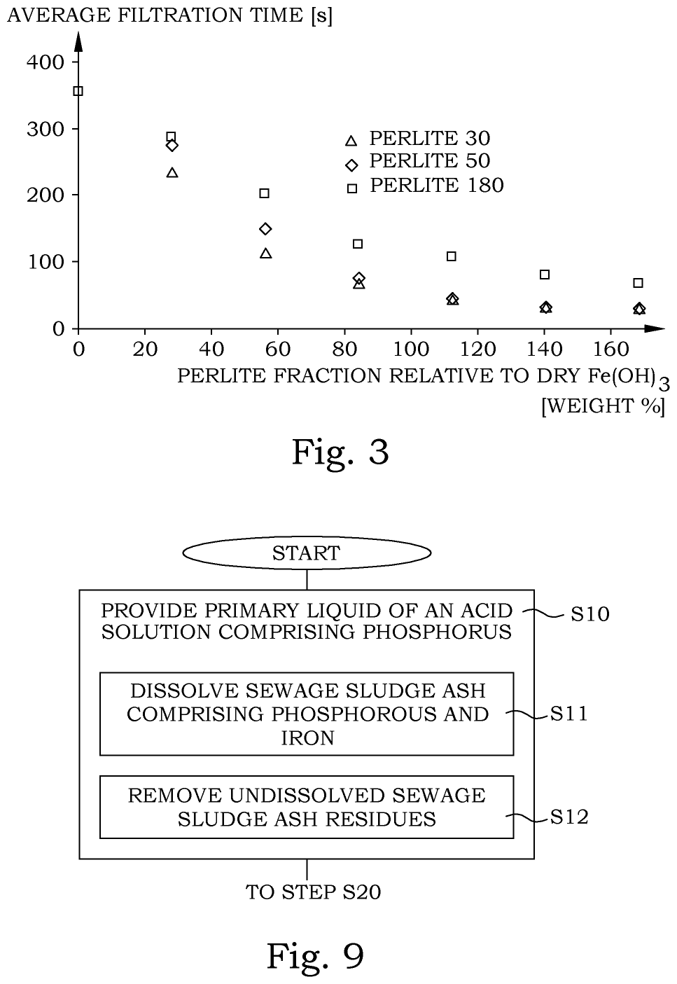

The solid filter-aid material may be of many different kinds. In one embodiment, the solid filter-aid material is selected as at least one of perlite, diatomaceous earth, and cellulose. Most of the experiments according to the principles described above are performed using perlite. Perlite 30, Perlite 50 and Perlite 180 was for instance used during filtration time tests, results of which are illustrated in FIG. 3. An average filtration time of the iron hydroxide from a solution of iron phosphate dissolved in sodium hydroxide was measured for different qualities of perlite and for different amounts of perlite. The diagram of FIG. 3 shows that for all perlite qualities, some effect of the filtration time was obtained even at relatively at low perlite fractions, at least down to about 15% by weight compared to dry iron hydroxide. At about 70% by weight of perlite, a significant decrease in average filtration time was achieved. At even higher fractions of perlite, the filtration speed indeed decreased even further, but at the expense of very large amounts of perlite. The perlite fraction was originally measured as weight-% relative to the dry iron phosphate entering the dissolution in the alkaline solution and then recalculated as a weight-% relative to a dry iron hydroxide content in the actual iron hydroxide filtering process.

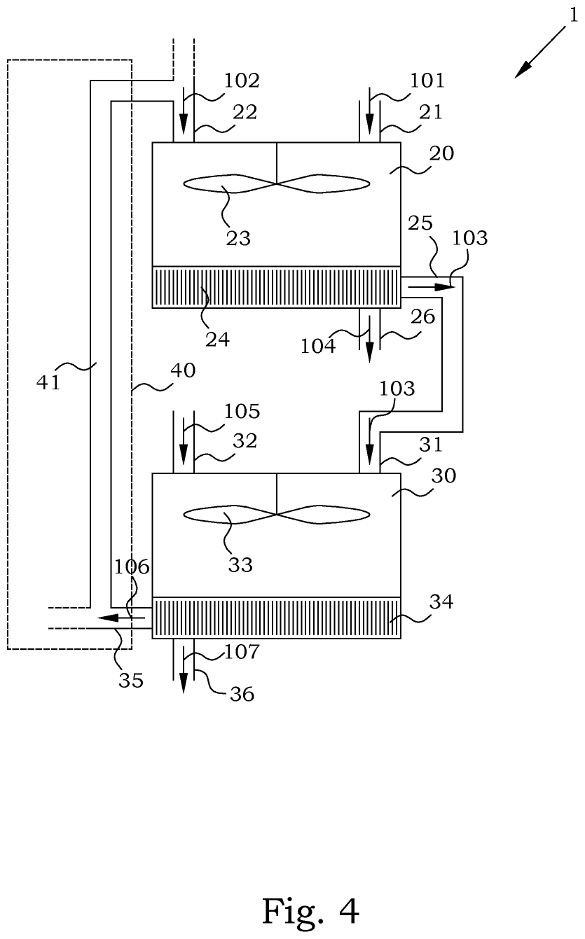

FIG. 4 illustrates schematically an embodiment of a system 1 for processing of phosphate compounds. The system 1 for processing of phosphate compounds comprises a phosphate compound precipitation section 20 and an iron hydroxide precipitation section 30.

The phosphate compound precipitation section 20 comprising a primary liquid inlet 21 for a primary liquid 101. The primary liquid 101 is an acid solution comprising at least phosphorous. The phosphate compound precipitation section 20 further comprises an additive material inlet 22 for a first additive material 102. This first additive material 102 comprises iron hydroxide and a solid filter-aid material. The phosphate compound precipitation section 20 further comprises a first arrangement for mixing 23 the primary liquid 101 and the first additive material 102. A precipitation of phosphate compounds comprising iron is caused. The phosphate compound precipitation section 20 further comprises a first filter 24 configured for separating first solid matter 103 from the primary liquid. The first solid matter comprises the precipitated phosphate compounds comprising iron and the solid filter-aid material. The phosphate compound precipitation section 20 also comprises a first solid matter outlet 25 for the first solid matter 103 and a filtered primary liquid outlet 26 for filtered primary liquid 104. The filtered primary liquid 104 is typically a solution of a salt of an acid used for dissolving phosphorus into the primary liquid.

The iron hydroxide precipitation section 30 comprises a solid matter inlet 31 for the first solid matter 103. The solid matter inlet 31 is thereby directly or indirectly connected to the first solid matter outlet 25 for providing the first solid matter 103. The iron hydroxide precipitation section 30 further comprises an alkaline inlet 32 for an alkaline solution 105. The iron hydroxide precipitation section 30 comprises a second arrangement for mixing 33 the first solid matter 103 and the alkaline solution 105. This causes precipitation of iron hydroxide in a secondary liquid 107. The iron hydroxide precipitation section 30 also comprises a second filter 34 for removing second solid matter 106 from the secondary liquid 107. The second solid matter 106 comprises the precipitated iron hydroxide and the solid filter-aid material. The iron hydroxide precipitation section 30 further comprises a second solid matter outlet 35 for the second solid matter 106 and a filtered secondary liquid outlet 36 for filtered secondary liquid 107. The filtered secondary liquid is an alkaline liquid solution comprising phosphorous.

The system 1 for processing of phosphate compounds further comprises a recycling arrangement 40. The recycling arrangement 40 has a first connection 41, connecting the second solid matter outlet 35 to the additive material inlet 22. The recycling arrangement 40 is thereby configured for recycling at least a first part of the second solid matter 106 as at least a part of the first additive material 102.

As indicated above, the present process is particularly well suited to process a primary liquid emanating from leaching of sewage sludge ash. Such primary liquid inevitably comprises phosphate ions as well as iron ions. Since the iron in the basic process above is circulated within the process, there will be a build-up of the iron content in the process liquids if not iron occasionally or continuously is removed from the circulating matter.

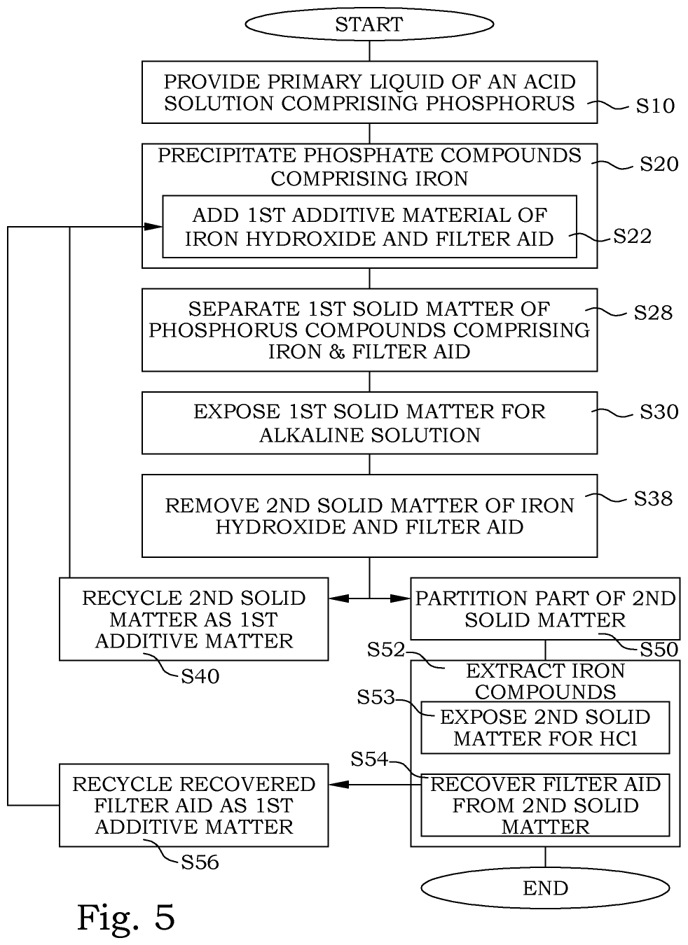

In an embodiment where the primary liquid comprises iron, the present method preferably comprises additional steps. FIG. 5 is a flow diagram of steps of another embodiment of a method for processing of phosphate compounds. Most steps are the same as in FIG. 2, and are not discussed if not being influenced by the additional steps.

As described in connection with FIG. 2, a first part of the second solid matter was recycled by step S40. As a complement, in step S50, a second part of the second solid matter is partitioned. In step S52, iron compounds are extracted from the second part of the second solid matter. These recovered iron compounds compensate for any amount of iron entered with the primary liquid. These steps could be performed as continuous processes, extracting the second part of the second solid matter continuously in dependence of the iron content of the entered primary liquid. These steps could alternatively be performed intermittently, e.g. when a concentration of iron in the circulation between steps S20 and S30 exceeds a predetermined level. In this way, excess iron is removed from the recycling part of the process.

A side effect of the removal of iron from the circulation process is that also a part of the solid filter-aid material is removed from the process. In order to maintain a requested level of solid filter-aid material, more solid filter-aid material has to be entered in step S22.

In a preferred embodiment, also the removed solid filter-aid material may be recirculated. To this end, the step S52 of extracting iron compounds from the second part of the second solid matter in turn comprises the part step S53, in which the second part of the second solid matter is exposed for a hydrochloric acid solution. This dissolves iron into a solution, whereby an iron chloride solution is produced. The iron chloride is a substance that has a certain commercial value and is used in many industrial processes. The solid filter-aid material is by this dissolving of iron released from the iron hydroxide. In step S54, solid filter-aid material is recovered from the second part of the second solid matter.

Preferably, as illustrated by step S56, the recovered solid filter-aid material is recycled as at least a part of the first additive material. In this way, the amount of solid filter-aid material is kept constant within the process, and only marginal losses caused during the different part processes have to be compensated for.

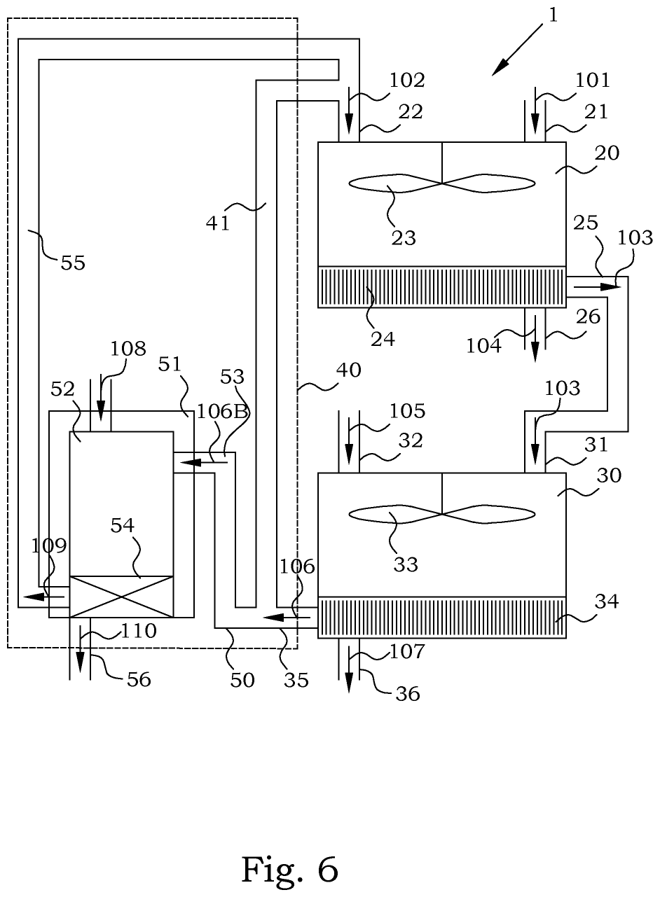

FIG. 6 illustrates schematically an embodiment of a system 1 for processing of phosphate compounds that is arranged for being capable of recovering iron provided in the primary liquid. In this embodiment, the recycling arrangement 40 of the system 1 for processing of phosphate compounds further comprises a partitioning arrangement 50 configured for partitioning a second part 106B of the second solid matter, and an extractor 51 configured for extracting iron compounds from the second part 106B of the second solid matter.

Preferably, the extractor 51 comprises a reactor 52 in which the second part 106B of the second solid matter is exposed for a hydrochloric acid solution 108. Iron is thereby dissolved, producing an iron chloride solution 110. The extractor 51 further comprises a recovering arrangement 54 configured for recovering solid filter-aid material 109 from the second part 106B of the second solid matter.

Preferably, the recycling arrangement 40 further comprises a second connection 55 connecting the recovering arrangement 54 and the additive material inlet 22. The second connection 55 is configured for recycling the recovered solid filter-aid material 109 as at least a part of the first additive material 102.

In the step S30 of FIGS. 2 and 5, the first solid matter, i.e. the precipitated phosphorus compounds comprising iron and the solid filter-aid material, is exposed for an alkaline solution in order to convert the phosphorous compounds into iron hydroxide and an alkaline solution comprising phosphates. This can be achieved by many different alkaline solutions. Preferably, the alkaline solution has a pH>12.

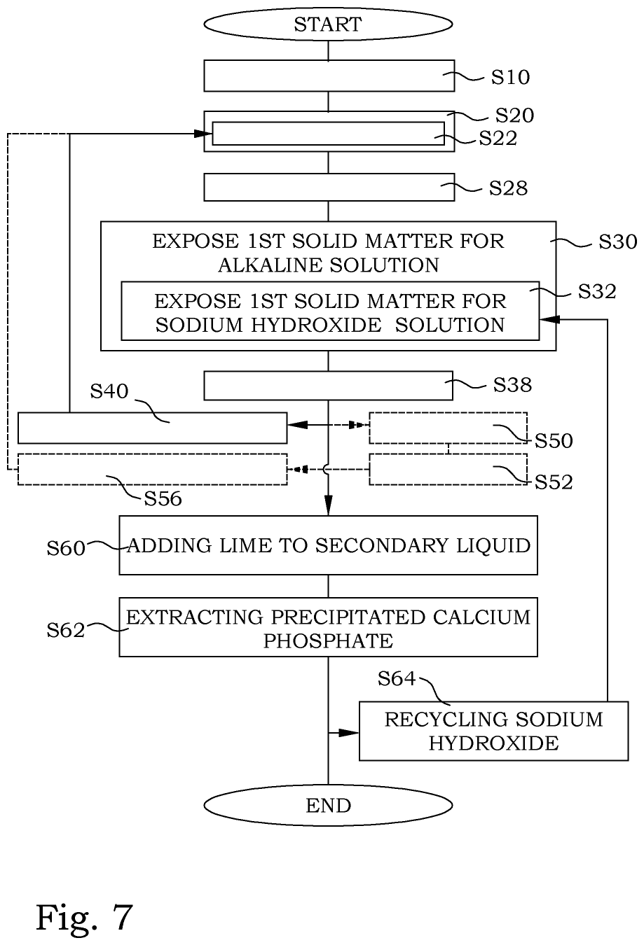

In one particularly advantageous embodiment, a solution of sodium hydroxide, i.e. caustic soda, is used for this purpose. In other words, the alkaline solution in the exposure comprises sodium hydroxide. FIG. 7 is a flow diagram of steps of yet another embodiment of a method for processing of phosphate compounds. Steps that are essentially equal to the earlier embodiments are not discussed in detail again, and some of the explaining texts are removed from the figure to make the figure easier to comprehend. This embodiment may be combined with any of the embodiments described here above.

Step S30 comprises in this embodiment step S32, in which the first solid matter is exposed for a sodium hydroxide solution. In other words, the alkaline solution comprises caustic soda. The filtered secondary liquid, remaining after step S38 then comprises dissolved sodium phosphate.

In step S60, lime is added to the secondary liquid after the step S38 of removing. The addition of lime causes precipitation of calcium phosphate and also a regeneration of a liquid comprising sodium hydroxide. Precipitated calcium phosphate is a commercially attractive substance and is used in many different industrial and/or agricultural processes. Therefore, as illustrated by step S62, the precipitated calcium phosphate is extracted from the liquid comprising sodium hydroxide.

Also the sodium hydroxide liquid is of interest as a commercial product. However, since sodium hydroxide is used in another step S32 of the present method, it is very convenient to recycle this extracted liquid comprising sodium hydroxide to be used in the exposure step S32. In other words, in step S64, at least a part of the liquid comprising sodium hydroxide is recycled as at least a part of the alkaline solution.

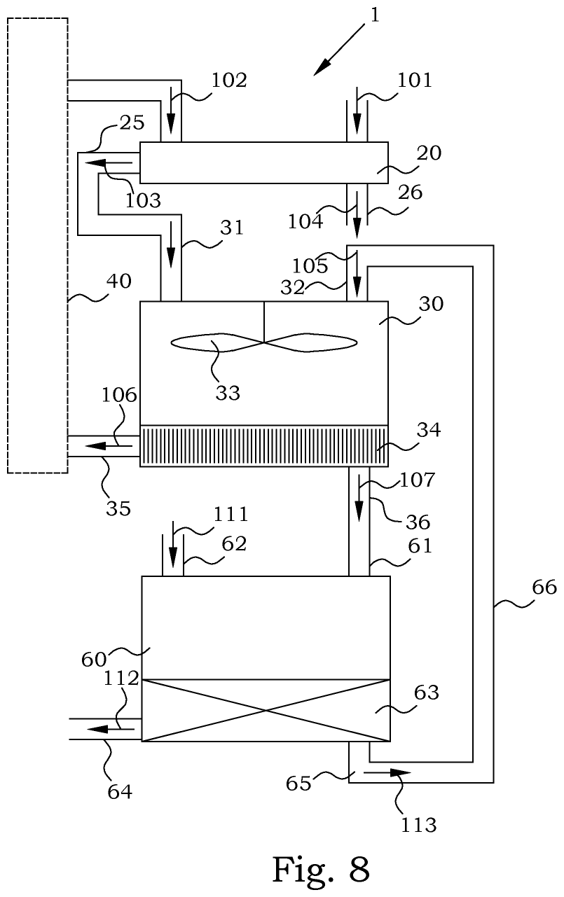

FIG. 8 illustrates schematically yet another embodiment of a system 1 for processing of phosphate compounds that is arranged for being capable of recovering phosphorous in a more valuable form. The system 1 for processing of phosphate compounds comprises a calcium phosphate reactor 60. The calcium phosphate reactor 60 has a filtered secondary liquid inlet 61 connected to the second solid matter outlet 36, whereby the alkaline solution 105 is transported from the iron hydroxide precipitation section 30 to the calcium phosphate reactor 60. The calcium phosphate reactor 60 further comprises a lime inlet 62 for addition of lime 111. If the alkaline solution 105 comprises sodium hydroxide, calcium phosphate 112 is precipitated. At the same time, a liquid 113 comprising sodium hydroxide is regenerated. The calcium phosphate reactor 60 further comprising an extractor 63 configured for extracting the precipitated calcium phosphate 112 through a calcium phosphate outlet 64 leaving the liquid 113 comprising sodium hydroxide. The calcium phosphate reactor 60 further comprising a filtered secondary liquid outlet 65 for the liquid comprising sodium hydroxide 113.

As mentioned above, it is preferred that the sodium hydroxide is circulated back within the system. To this end, in a preferred embodiment, a third connection 66 between the filtered secondary liquid outlet 65 and the alkaline solution inlet 32 is configured for recycling at least a part of the liquid 113 comprising sodium hydroxide as at least a part of the alkaline solution 105. As indicated in the background, the present technology was developed intended to be used in the recovery of phosphates from sewage sludge, and in particular from sewage sludge ash. However, the technology is more generally applicable to different processes in which phosphorus is to be separated from different types of acid solutions.

However, in one particular embodiment, the primary liquid has its original in sewage sludge ash treatment. FIG. 9 illustrates a flow diagram of an embodiment of step S10 of providing primary liquid of an acid solution comprising phosphorus. In step S11, sewage sludge ash comprising phosphorous and iron is dissolved in a mineral acid. In step S12, undissolved sewage sludge ash residues are removed, thereby giving the primary liquid. Since iron compounds typically are used in sewage treatment processes to e.g. precipitate phosphorous, the sewage sludge ash always comprises some iron. Since iron already is present in the chemical system, the use of iron hydroxide in the remaining process of the present technology becomes particularly advantageous.

In a preferred embodiment, the mineral acid is hydrochloric acid.

A primary liquid emanating from sewage sludge ash typically comprises phosphorus and iron as well as various other substances, such as e.g. heavy metals. Therefore, in a preferred embodiment, precipitation of phosphorous compounds comprising iron, e.g. FePO₄, is caused by adapting the pH to 2.5-3.5, preferably around pH 3. At lower pH, the solubility of FePO₄ is still relatively high, causing a low efficiency of phosphorus extraction from the liquid. At higher pH, there is instead a risk that for instance heavy metal phosphates and calcium phosphates are precipitated since the solubility thereof decreases. A pH of around 3 will precipitate most of the iron phosphate, but only minor amounts of the other phosphates.

If Ca(OH)₂ is used for increasing the pH, the remaining filtered primary liquid after precipitation of phosphorous compounds comprising iron typically comprises dissolved salts based on the acid used in the primary liquid together with heavy metals or calcium.

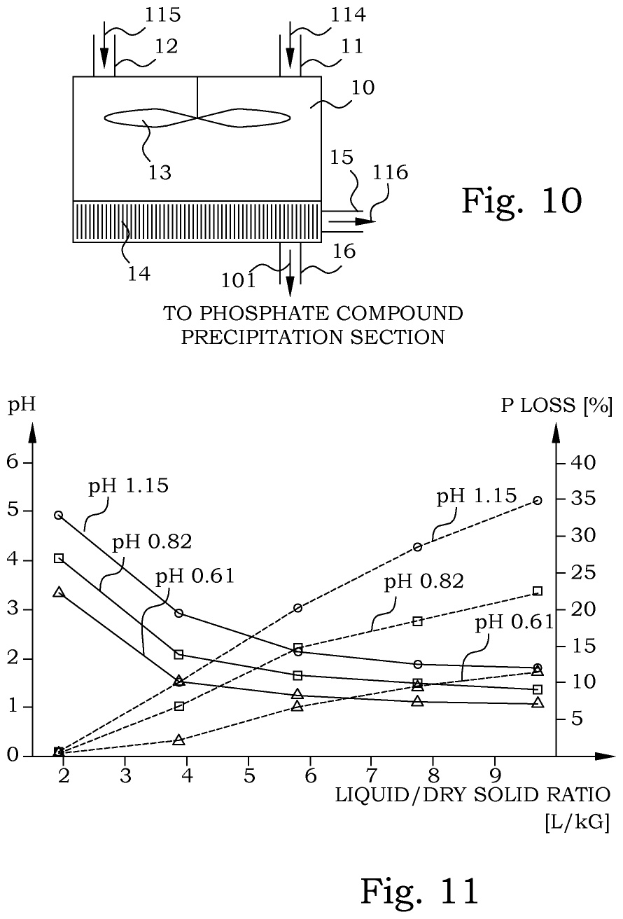

Analogously, FIG. 10 illustrates schematically an embodiment of a leachate reactor 10. The leachate reactor 10 is configured for dissolving sewage sludge ash comprising phosphorous and iron in a mineral acid and for removing undissolved sewage sludge ash residues. To this end, the leachate reactor 10 comprises an ash inlet 11 for admitting entrance of sewage sludge ash 114 and a mineral acid inlet 12 for admitting addition of a mineral acid 115. Preferably, the mineral acid is hydrochloric acid. A third mixing arrangement 13 is used to mix the sewage sludge ash 114 and the mineral acid 115 to promote dissolution of phosphorus. A third filter 14 is used for separating the undissolved sewage sludge ash residues 116. The undissolved sewage sludge ash residues 116 are exited through a residue outlet 15. This results in a solution being advantageously used as the primary liquid. A primary liquidoutlet 16 for the primary liquid 101 from the leachate reactor 10 is directly or indirectly connected to the primary liquid inlet 21 of the phosphate compound precipitation section.

One part of the process that is of particular interest is the efficiency extraction of phosphorus from the primary liquid. A high yield of course increases the economic advantages of this technology. Also, a low phosphorus content in the remaining liquid after this step is also of interest for e.g. environmental reasons.

The efficiencies of the reactions for phosphorous removal by ferric hydroxide are therefore of large interest. In a chemical process reacting phosphorous acid and iron hydroxide by dissolution and precipitation, the reaction can be described as:

H₃PO₄+Fe(OH)₃→Fe³⁺+PO₄³⁻+3H₂0→FePO₄↓+3H₂0

In this reaction each phosphate ion is matched with one iron ion and the efficiency of extracting phosphate ions from the solution is thereby relatively high.

However, there are competing processes. One adsorption-like alternative can be defined as:

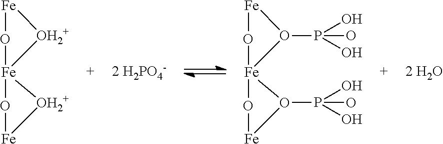

In this process, three iron atoms are required for binding two phosphate ions, making this path less efficient in phosphate extraction.

A high efficiency of phosphorous capture may always be obtained by providing large amounts of iron hydroxide into the primary liquid. However, large amounts of iron hydroxide will cause the primary liquid to turn into thick slurry with a relatively high pH. This is difficult to process in an industrial manner, and there has to be some compromises between phosphorus removal efficiency and processability.

FIG. 11 is a diagram illustrating the results of some test experiments. Three different leach solutions were obtained by leaching of sewage sludge ash by hydrochloride acid, with different chloride concentrations between 3 and 5.5%. The corresponding pH of these leaches were 0.61, 0.82 and 1.15, respectively. For each of the leach solutions, a Fe(OH)₃ cake was added in different liquid/dry solid ratios. After agitation during about 1 hour and a subsequent adjustment of the pH to about 3, the resulting pH and the phosphorous content in was analyzed. This was performed by partially filtering the resulting slurry on syringe filter and the filtrate was analyzed for P content.

In the diagram, the fraction of phosphorous remaining in solution is illustrated by dotted lines and the scale at the right hand side. The full lines and the left-hand scale represent the final pH of the slurry. Here, it can be seen that an essentially total extraction of phosphorous can be obtained by very low liquid/dry solid ratios. However, as indicated above, such slurries are more difficult to handle in an industrial environment. It is also seen that different original pH of the leach resulted in different efficiency in extracting phosphorus. A lower pH leach allowed a more efficient phosphorous extraction. The explanation is that at lower pH more Fe(OH)₃ is dissolved, thereby releasing free Fe ions and removing more phosphorus, as compared to the conditions at higher pH. Less than 5% phosphorous loss could e.g. be achieved at a liquid/dry solid ratio of about 5, which would give a reasonable thin slurry, with an original leach of pH 0.61.

As mentioned above, precipitation of phosphorous compounds comprising iron, e.g. FePO₄, is preferably caused by adapting the pH to 2.5-3.5, preferably around pH 3. However, at such pH, the dissolution of Fe(OH)₃ is low. A continuous process where the phosphorous extraction is performed essentially at pH 3 will thus result in a relatively low phosphorous extraction.

In a preferred embodiment of the present technology, it is instead suggested to first ensure a high dissolution of iron before the pH is adjusted to cause precipitation of phosphorous compounds comprising iron. In other words, the precipitation of phosphorous compounds comprising iron is divided into two parts. This can be performed either as subsequent process steps in a single batch reactor, which is not very attractive in an industrial view, or as continuous processes in two subsequent reactors, which is of higher industrial importance.

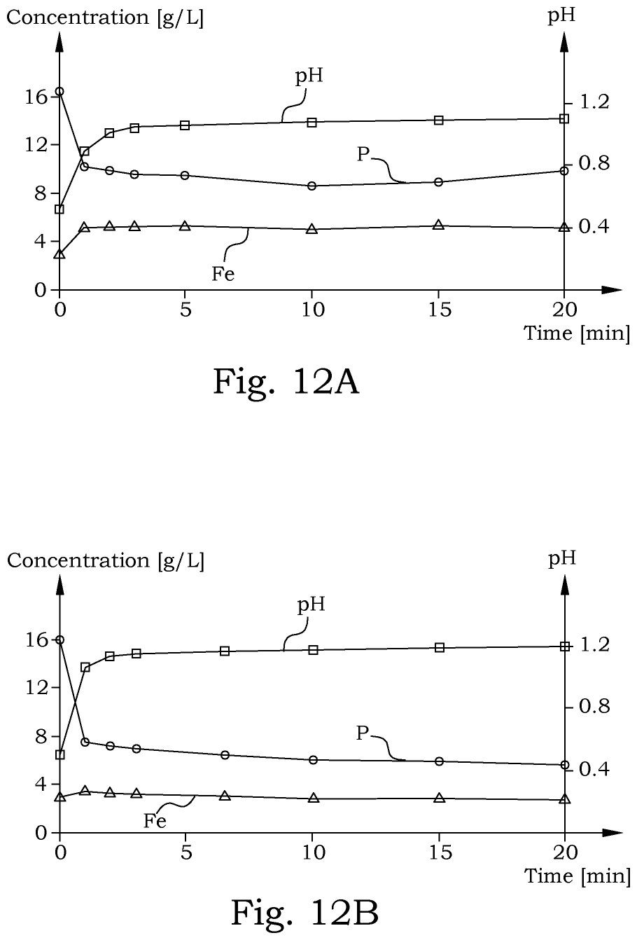

Additional experiments were performed, investigating the timing aspect of such a division. An ash leach solution was obtained by dissolving sewage sludge ash in hydrochloric acid at a liquid to solid ratio of 5. The leach solution had an HCl-concentration of ca 6,6%, corresponding to a pH of about 0.5. Ferric hydroxide cake containing perlite was added to the ash leach solution. The pH was monitored continuously. Samples were taken during the agitation, filtered on syringe filter and the filtrate was analyzed for P and Fe content by a spectrophotometric method. Two different liquid/dry solid ratios 5.3 and 4.0, respectively, between leach solution and ferric hydroxide were used. The results are illustrated in FIGS. 12A and 12B.

In FIG. 12A, the original liquid/dry solid ratio was 5.3. After 20 minutes, iron hydroxide is dissolved and the liquid/dry solid ratio has increased to about. 6.6. It can be seen that first few minutes, the pH increases, due to dissolution of iron hydroxide. The phosphorous content decreases, due to precipitation of phosphate compounds comprising iron. The dissolution of iron hydroxide is also seen as an increase in the iron content. It can be noticed that the dissolution of iron hydroxide is most efficient at pH below 1. When the pH increases to higher values, the dissolution of iron is reduced significantly.

In FIG. 12B, the original liquid/dry solid ratio was 4.0. After 20 minutes, iron hydroxide is dissolved and the liquid/dry solid ratio has increased to about. 4.9. Basically the same behavior is repeated. The iron dissolution mainly takes place at pH below 1. A limited dissolution of iron is therefore present, regardless of the amount of iron hydroxide added to the process.

In the patent EP 3623348 B, it was reported that gel formation resulted for a low molar ratio of [P/(Fe+Al)]≤1. However, since the dissolved iron gives a P/Fe molar ratio typically above 3, no gel formation was obtained independent on the large amount of Fe(OH)₃ available for dissolution.

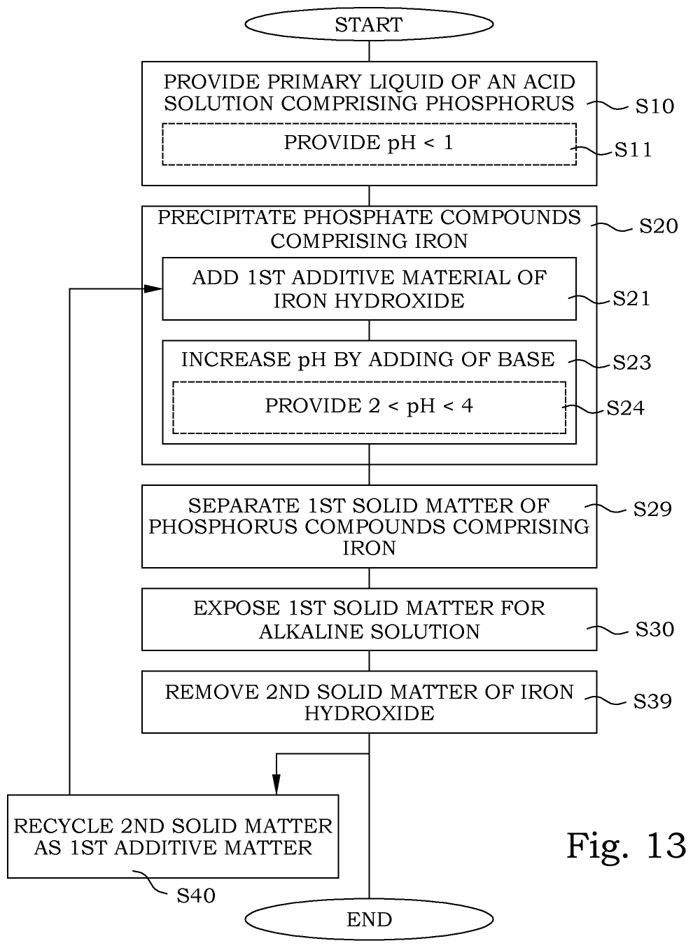

FIG. 13 is a flow diagram of steps of an embodiment for processing of phosphate compounds. In step S10, a primary liquid of an acid solution comprising phosphorus is provided. In particular embodiments, the primary liquid may emanate from dissolved sewage sludge ash, as described above. Preferably, as indicated by step S11, the primary liquid has a pH<1. In step S20 phosphate compounds comprising iron are precipitated. The step S20 of precipitating phosphate compounds comprising iron from the primary liquid comprises a first part step S21 followed by a second part step S22. In the first part step S21, first additive material is added to the primary liquid. The first additive material comprises iron hydroxide. In a preferred embodiment, and as described above, the first additive material also comprises a solid filter-aid material, i.e., step S21 may comprise the step S22 of FIG. 2. In the second part step S23 pH is increased by adding of a base. In a preferred embodiment, as indicated in step S24, the base is added in an amount giving a pH in the interval of 2 to 4. In a preferred embodiment, the base added in the second part step S23 comprises lime.

As mentioned above, steps S21 and S23 may be performed as consecutive steps in a single reactor. However, in order to increase the advantages in an industrial production, in a preferred embodiment, the first part step and the second part steps are continuous processes performed in separate reactors.

In step S29, first solid matter is separated. The first solid matter comprises phosphorous compounds comprising iron. In a preferred embodiment, and as described above, the first solid material also comprises the solid filter-aid material, i.e., step S29 may comprise the step S28 of FIG. 2. In step S30, the first solid matter is exposed for an alkaline solution. In step S39, second solid matter is removed. The second solid matter comprises iron hydroxide. In a preferred embodiment, and as described above, the second solid material also comprises the solid filter-aid material, i.e., step S39 may comprise the step S38 of FIG. 2. In step S40, at least a part of the second solid mater is recycled as the first solid matter.

The reactions in step S21 are rapid, as shown in the experiments above, and are typically complete in about 10 minutes. The second reaction, in step S23, is limited by reactivity of lime dissolution, which may take about 20 minutes. For designing a continuous system, somewhat longer reaction times are preferred, such as e.g. 20-30 minutes for step S21 and about 40 min for step S23.

Continuous tests have been performed according to the above presented ideas. Phosphorous removal efficiencies of more than 95% was readily obtained for the two-part-process system in continuous operation.

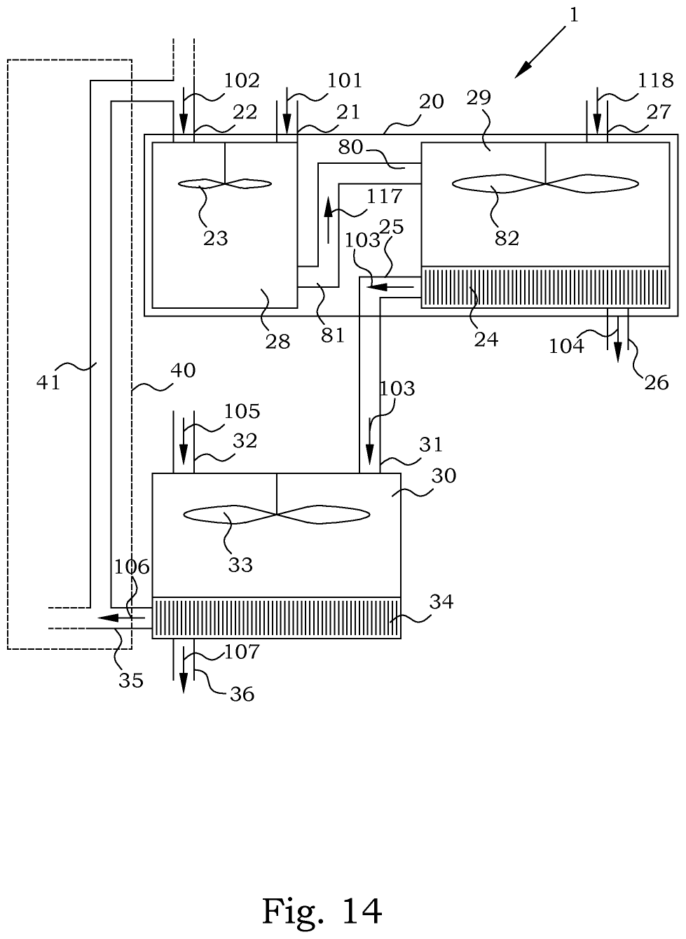

FIG. 14 illustrates schematically an embodiment of a system 1 for processing of phosphate compounds. The system 1 for processing of phosphate compounds comprises a phosphate compound precipitation section 20 and an iron hydroxide precipitation section 30.

The phosphate compound precipitation section 20 comprising a primary liquid inlet 21 for a primary liquid 101. The primary liquid 101 is an acid solution comprising at least phosphorous. The phosphate compound precipitation section 20 further comprises an additive material inlet 22 for a first additive material 102. This first additive material 102 comprises iron hydroxide. Preferably, the first additive material also comprises a solid filter-aid material.

The phosphate compound precipitation section 20 comprises a first reactor 28. The first reactor 28 has the primary liquid inlet 21 and the additive material inlet 22, and furthermore the first arrangement for mixing 23. The phosphate compound precipitation section 20 further comprises a second reactor 29. The second reactor 29 has the first solid matter outlet 25 and the filtered primary liquid outlet 26. The first reactor 28 further comprising a mix outlet 81 for a mix 117 between the first additive material 102 and the primary liquid 101. The second reactor further comprising a mix inlet 80, connected to the mix outlet 81, for the mix 117 between the first additive material 102 and the primary liquid 101. The second reactor 29 further comprising a base inlet 27, for a base 118, whereby an increase of a pH of the mix 117 between the first additive material 101 and the primary liquid 101 is achieved. Preferably, an additional arrangement for mixing 82 is used for this purpose.

Preferably, the first reactor and the second reactor are continuous process reactors.

A precipitation of phosphate compounds comprising iron is caused. The phosphate compound precipitation section 20 further comprises a first filter 24 configured for separating first solid matter 103 from the primary liquid. The first solid matter comprises the precipitated phosphate compounds comprising iron. Preferably, the first solid matter also comprises solid filter-aid material. The phosphate compound precipitation section 20 also comprises a first solid matter outlet 25 for the first solid matter 103 and a filtered primary liquid outlet 26 for filtered primary liquid 104. The filtered primary liquid 104 is typically a solution of a salt of an acid used for dissolving phosphorus into the primary liquid.

The iron hydroxide precipitation section 30 comprises a solid matter inlet 31 for the first solid matter 103. The solid matter inlet 31 is thereby directly or indirectly connected to the first solid matter outlet 25 for providing the first solid matter 103. The iron hydroxide precipitation section 30 further comprises an alkaline inlet 32 for an alkaline solution 105. The iron hydroxide precipitation section 30 comprises a second arrangement for mixing 33 the first solid matter 103 and the alkaline solution 105. This causes precipitation of iron hydroxide in a secondary liquid 107. The iron hydroxide precipitation section 30 also comprises a second filter 34 for removing second solid matter 106 from the secondary liquid 107. The second solid matter 106 comprises the precipitated iron hydroxide. Preferably, the second solid matter 106 also comprises the solid filter-aid material. The iron hydroxide precipitation section 30 further comprises a second solid matter outlet 35 for the second solid matter 106 and a filtered secondary liquid outlet 36 for filtered secondary liquid 107. The filtered secondary liquid is an alkaline liquid solution comprising phosphorous.

The system 1 for processing of phosphate compounds further comprises a recycling arrangement 40. The recycling arrangement 40 has a first connection 41, connecting the second solid matter outlet 35 to the additive material inlet 22. The recycling arrangement 40 is thereby configured for recycling at least a first part of the second solid matter 106 as at least a part of the first additive material 102.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1-24. (canceled)

25. A method for processing of phosphate compounds, comprising the steps of:
providing a primary liquid, said primary liquid being an acid solution comprising at least phosphorous;
precipitating phosphate compounds comprising iron from said primary liquid;
said step of precipitating phosphate compounds comprising iron comprises adding of a first additive material to said primary liquid;
said first additive material comprises iron hydroxide and a solid filter-aid material;
separating first solid matter of said precipitated phosphate compounds comprising iron and said solid filter-aid material from said primary liquid by a first filtering;
exposing said separated first solid matter for an alkaline solution;
said alkaline solution thereby causing a dissolution of phosphate compounds and precipitation of iron hydroxide, giving a secondary liquid;
removing second solid matter of said precipitated iron hydroxide and said solid filter-aid material from said secondary liquid by a second filtering;
whereby said secondary liquid after said step of removing is an alkaline liquid solution comprising phosphorous; and
recycling at least a first part of said second solid matter as at least a part of said first additive material.

26. The method according to claim 25, wherein said additive material comprises said solid filter-aid material in an amount giving at least 15% by weight, preferably at least 45% be weight, and more preferably at least 70% by weight, of said solid filter-aid material in said second solid matter.

27. The method according to claim 25, wherein said solid filter-aid material has a porous structure and is chemically inert in the pH range from 0.8 to 12.2.

28. The method according to claim 27, wherein said solid filter-aid material is selected as at least one of:
perlite
diatomaceous earth, and
cellulose.

29. The method according to claim 28, comprising the further step of
partitioning a second part of said second solid matter;
extracting iron compounds from said second part of said second solid matter;
whereby said recovered iron compounds compensates for the amount of iron entered with said primary liquid.

30. The method according to claim 29, wherein the step of extracting iron compounds from said second part of said second solid matter in turn comprises the part steps of:
exposing said second part of said second solid matter for a hydrochloric acid solution, dissolving iron, whereby an iron chloride solution is produced; and
recovering solid filter-aid material from said second part 106B of said second solid matter.

31. The method according to claim 30, comprising the further step of
recycling said recovered solid filter-aid material as at least a part of said first additive material.

32. The method according to claim 25, wherein said alkaline solution has a pH>12.

33. The method according to claim 25, wherein the step of precipitating phosphate compounds comprising iron from said primary liquid comprises a first part step followed by a second part step;
wherein said first part step comprises adding said first additive material to said primary liquid; and
wherein said second part step comprises a step of increasing a pH by adding of a base.

34. The method according to claim 33, wherein said primary liquid has a pH<1 and wherein said base in said second part step is added in an amount giving a pH in the interval of 2 to 4.

35. The method according to claim 25, wherein said alkaline solution comprises sodium hydroxide, whereby said method comprises the further steps of
adding lime to said secondary liquid after said step of removing, causing precipitation of calcium phosphate and regeneration of a liquid comprising sodium hydroxide; and
extracting said precipitated calcium phosphate from said liquid comprising sodium hydroxide.

36. The method according to claim 35, comprising the further step of
recycling at least a part of said liquid comprising sodium hydroxide as at least a part of said alkaline solution.

37. The method according to claim 25, wherein the step of providing said primary liquid in turn comprises the steps of:
dissolving sewage sludge ash comprising phosphorous and iron in a mineral acid; and
removing undissolved sewage sludge ash residues, thereby giving said primary liquid.

38. A system for processing of phosphate compounds, comprising:
a phosphate compound precipitation section;
an iron hydroxide precipitation section;
said phosphate compound precipitation section comprising a primary liquid inlet for a primary liquid, said primary liquid being an acid solution comprising at least phosphorous;
said phosphate compound precipitation section comprising an additive material inlet for a first additive material, said first additive material comprises iron hydroxide and a solid filter-aid material;
said phosphate compound precipitation section comprising a first arrangement for mixing said primary liquid and said first additive material, causing precipitation of phosphate compounds comprising iron;
said phosphate compound precipitation section comprising a first filter configured for separating first solid matter of said precipitated phosphate compounds comprising iron and said solid filter-aid material from said primary liquid;
said phosphate compound precipitation section comprising a first solid matter outlet for said first solid matter;
said phosphate compound precipitation section comprising a filtered primary liquid outlet for filtered said primary liquid;
said iron hydroxide precipitation section comprising a solid matter inlet for said first solid matter, connected to said first solid matter outlet;
said iron hydroxide precipitation section comprising an alkaline solution inlet for an alkaline solution;
said iron hydroxide precipitation section comprising a second arrangement for mixing said first solid matter and said alkaline solution, causing precipitation of iron hydroxide in a secondary liquid;
said iron hydroxide precipitation section comprising a second filter for removing second solid matter of said precipitated iron hydroxide and said solid filter-aid material from said secondary liquid;
said iron hydroxide precipitation section comprising a second solid matter outlet for said second solid matter;
said iron hydroxide precipitation section comprising a filtered secondary liquid outlet for filtered said secondary liquid, being an alkaline liquid solution comprising phosphorous; and
a recycling arrangement having a first connection, connecting said second solid matter outlet to said additive material inlet, and being configured for recycling at least a first part of said second solid matter as at least a part of said first additive material;
wherein said recycling arrangement further comprises a partitioning arrangement configured for partitioning a second part of said second solid matter, and an extractor configured for extracting iron compounds from said second part of said second solid matter; and
wherein said extractor comprises a reactor in which said second part of said second solid matter is exposed for a hydrochloric acid solution, thereby dissolving iron, producing an iron chloride solution, and a recovering arrangement configured for recovering solid filter-aid material from said second part of said second solid matter.

39. The system according to claim 38, wherein said recycling arrangement further comprises a second connection connecting said recovering arrangement and said additive material inlet, and being configured for recycling said recovered solid filter-aid material as at least a part of said first additive material.

40. The system according to claim 38, wherein said phosphate compound precipitation section comprises a first reactor, having said primary liquid inlet and said additive material inlet, and a second reactor, having said first solid matter outlet and said filtered primary liquid outlet;
said first reactor further comprising a mix outlet for a mix between said first additive material and said primary liquid;
said second reactor further comprising a mix inlet, connected to said mix outlet, for said mix between said first additive material and said primary liquid;
said second reactor further comprising a base inlet, for a base, whereby an increase of a pH of said mix between said first additive material and said primary liquid is achieved.

41. The system according to claim 40, wherein said first reactor and said second reactor are continuous process reactors.

42. The system according to claim 38, comprising a calcium phosphate reactor having a filtered secondary liquid inlet connected to said filtered secondary liquid outlet, a lime inlet for addition of lime, whereby, if said alkaline solution comprises sodium hydroxide, calcium phosphate is precipitated, regenerating of a liquid comprising sodium hydroxide;
said calcium phosphate reactor further comprising an extractor configured for extracting said precipitated calcium phosphate through a calcium phosphate outlet from said liquid comprising sodium hydroxide; and
said calcium phosphate reactor further comprising an alkaline solution outlet for said liquid comprising sodium hydroxide.

43. The system according to claim 42, comprising a third connection between said alkaline solution outlet and said alkaline solution inlet configured for recycling at least a part of said liquid comprising sodium hydroxide as at least a part of said alkaline solution.

44. The system according to claim 38, comprising a leachate reactor configured for dissolving sewage sludge ash comprising phosphorous and iron in a mineral acid and for removing undissolved sewage sludge ash residues, thereby giving said primary liquid; wherein a primary liquid outlet for said primary liquid from said leachate reactor is connected to said primary liquid inlet.
